(19) United States
(12) Patent Application Publication
(10) Pub. No.: US 2025/0201803 A1
(43) Pub. Date: Jun. 19, 2025

(54) POSITIVE ELECTRODE FOR NON-AQUEOUS ELECTROLYTE SECONDARY BATTERY, NON-AQUEOUS ELECTROLYTE SECONDARY BATTERY USING SAME, BATTERY MODULE, AND BATTERY SYSTEM

(71) Applicant: SEKISUI CHEMICAL CO., LTD., Osaka (JP)

(72) Inventors: Hikaru YOSHIKAWA, Tsukuba-shi (JP); Taro MOMOZAKI, Tsukuba-shi (JP); Yuichi SABI, Tsukuba-shi (JP)

(73) Assignee: SEKISUI CHEMICAL CO., LTD., Osaka (JP)

(21) Appl. No.: 18/846,450

(22) PCT Filed: Mar. 15, 2023
(86) PCT No.: PCT/JP2023/010133

§ 371 Date: Sep. 12, 2024

(30) Foreign Application Priority Data
Mar. 15, 2022 (JP) 2022-040527

(51) Int. Cl. H01M 4/131; H01M 4/02; H01M 4/36; H01M 4/58; H01M 4/62

(52) U.S. Cl. CPC H01M 4/131; H01M 4/366; H01M 4/5825; H01M 4/625; H01M 2004/021; H01M 2004/028

(57) ABSTRACT

A positive electrode for a non-aqueous electrolyte secondary battery, includes a current collector and a positive electrode active material layer provided on the current collector, wherein: the current collector has, on at least a part of its surface on a side of the positive electrode active material layer, a current collector coating layer, the positive electrode active material layer includes positive electrode active material particles, the positive electrode active material particles include a core section consisting of a positive electrode active material, and an active material coating section covering the core section, each of the current collector coating layer and the active material coating section comprises a conductive material, and when a thickness of the current collector coating layer is defined as A μm and a median diameter in a particle size distribution of particles present in the positive electrode active material layer is defined as B μm.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2022-040527, filed Mar. 15, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector. Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 describes a method for improving the cycle life of a positive electrode of a non-aqueous electrolyte secondary battery by providing a conductive coating layer containing carbon as a conducting agent between an aluminum foil current collector and a positive electrode active material layer containing a lithium transition metal composite oxide.

### PRIOR ART DOCUMENT

### Patent Document

Patent Document 1: Japanese Unexamined Patent Application Publication No. 2001-351612

### SUMMARY OF THE INVENTION

### Problems to be Solved by the Invention

The method described in PTL 1 is not necessarily satisfactory, and further improvement of battery performance is required.

An object of the present invention is to provide a positive electrode for a non-aqueous electrolyte secondary battery, which is capable of not only reducing the impedance of the non-aqueous electrolyte secondary battery, but also increasing its energy density.

### Means for Solving the Problems

The embodiments of the present invention are as follows.

[1] A positive electrode for a non-aqueous electrolyte secondary battery, comprising a current collector and a positive electrode active material layer provided on the current collector, wherein: the current collector has, on at least a part of its surface on a side of the positive electrode active material layer, a current collector coating layer; the positive electrode active material layer comprises positive electrode active material particles; the positive electrode active material particles comprise a core section consisting of a positive electrode active material, and an active material coating section covering the core section; each of the current collector coating layer and the active material coating section comprises a conductive material; and when a thickness of the current collector coating layer is defined as A μm and a median diameter in a particle size distribution of particles present in the positive electrode active material layer is defined as B μm, A/B is 0.007 or more and 0.050 or less, 0.010 to 0.045, or 0.015 to 0.040.

[2] The positive electrode according to [1], wherein B is 10.0 to 80.0 μm, 15.0 to 75.0 μm, or 20.0 to 70.0 μm.

[2-1] The positive electrode according to [1], wherein B is 10.0 μm or more and less than 64.0 μm.

[2-2] The positive electrode according to [1], wherein B is 10.0 to 30.0 μm.

[2-3] The positive electrode according to [1], wherein B is 10.0 to 25.0 μm.

[3] The positive electrode according to any one of [1], [2] and [2-1] to [2-3], wherein A is less than 3.0 μm, 0.01μ m to 2.5 μm, 0.05μ m to 2.0 μm, or 0.10μ m to 2.0μ m.

[3-1] The positive electrode according to any one of [1] to [3] (including [2-1] to [2-3]), wherein A is 0.1 μm or more and less than 1.0 μm.

[3-2] The positive electrode according to any one of [1] to [3] (including [2-1] to [2-3]), wherein A is 0.1 to 0.7 μm.

[3-3] The positive electrode according to any one of [1] to [3] (including [2-1] to [2-3]), wherein A is 0.1 to 0.6 μm.

[3-4] The positive electrode according to any one of [1] to [3] (including [2-1] to [2-3]) and [3-1] to [3-3], wherein A/B is 0.24 or more and 0.050 or less.

[3-5] The positive electrode according to any one of [1] to [3] (including [2-1] to [2-3]) and [3-1] to [3-3], wherein A/B is 0.30 or more and 0.050 or less.

[4] The positive electrode according to any one of [1] to [3] (including [2-1] to [2-3] and [3-1] to [3-5]), wherein the positive electrode active material layer comprises a conductive carbon, and an amount of the conductive carbon is 0.5% by mass or more and less than 3.0 μm.

[4] The positive electrode according to any one of [1] to [4] (including [2-1] to [2-3] and [3-1] to [3-5]), wherein the positive electrode active material particles comprise a compound represented by a formula LiFeₓM₍₁₋ₓ₎PO₄, wherein 0≤x≤1, M is Co, Ni, Mn, Al, Ti or Zr.

[6] The positive electrode according to any one of [1] to [5] (including [2-1] to [2-3] and [3-1] to [3-5]), wherein the positive electrode active material layer comprises a binder.

[7] A non-aqueous electrolyte secondary battery, comprising the positive electrode of any one of [1] to [6] (including [2-1] to [2-3] and [3-1] to [3-5]), a negative electrode, and a non-aqueous electrolyte disposed between the positive electrode and the negative electrode.

[8] A battery module or battery system comprising a plurality of the non-aqueous electrolyte secondary batteries of [7].

### Effect of the Invention

The present invention can provide a positive electrode for a non-aqueous electrolyte secondary battery, which is capable of not only reducing the impedance of the non-aqueous electrolyte secondary battery, but also increasing its energy density.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

### EMBODIMENTS TO CARRY OUT THE INVENTION

In the present specification and claims, “to” indicating a numerical range means that the numerical values described before and after “to” are included as the lower limit and the upper limit of the range.

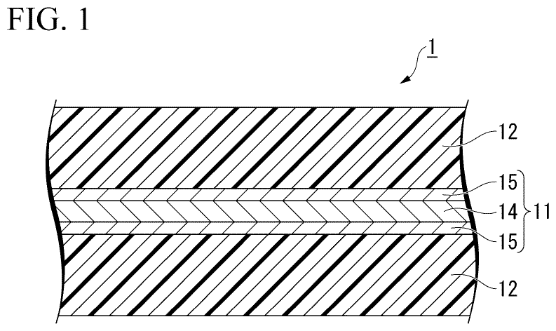

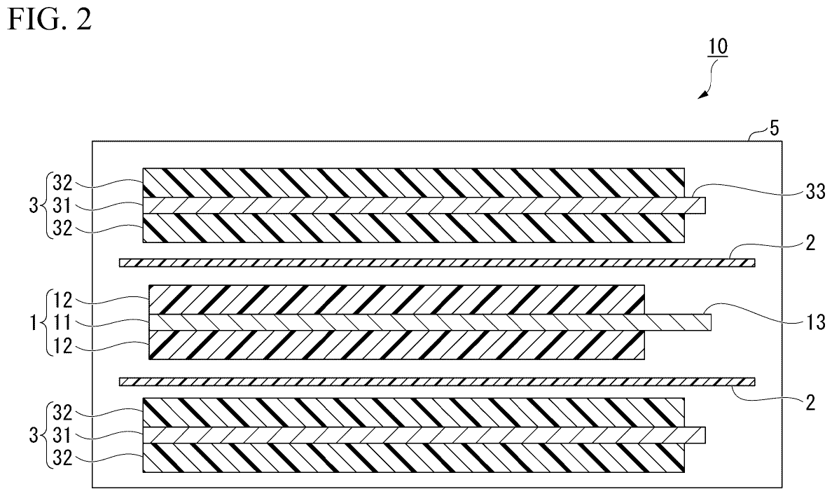

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

### <Positive Electrode for Non-Aqueous Electrolyte Secondary Battery>

In the present embodiment, the positive electrode for a non-aqueous electrolyte secondary battery (hereinafter also referred to as “positive electrode”) 1 has a current collector (hereinafter referred to as “positive electrode current collector”) 11 and a positive electrode active material layer 12.

The positive electrode active material layer 12 is present on at least one surface of the positive electrode current collector 11. The positive electrode active material layers 12 may be present on both sides of the positive electrode current collector 11.

The positive electrode current collector 11 has current collector coating layers 15 on at least part of its surfaces facing the positive electrode active material layers 12. That is, the positive electrode current collector 11 has a positive electrode current collector main body 14 and current collector coating layers 15 that cover the positive electrode current collector main body 14 on its surfaces facing the positive electrode active material layers 12.

### [Positive Electrode Active Material Layer]

The positive electrode active material layer 12 includes positive electrode active material particles.

The positive electrode active material layer 12 preferably further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material.

The positive electrode active material layer 12 may further include a dispersant. The amount of the positive electrode active material particles is preferably 80.0 to 99.9% by mass, and more preferably 90 to 99.5% by mass, based on the total mass of the positive electrode active material layer 12.

The thickness of the positive electrode active material layer is preferably 30 to 500 μm, more preferably 40 to 400 μm, particularly preferably 50 to 300 μm. When the thickness of the positive electrode active material layer is not less than the lower limit value of the above range, the energy density of a battery with the positive electrode incorporated therein tends to improve. When the thickness is not more than the upper limit value of the above range, the peel strength of the positive electrode active material layer can be improved, thereby preventing delamination of the positive electrode active material layer during charging/discharging. When the positive electrode active material layers are present on both sides of the positive electrode current collector, the thickness of the positive electrode active material layer is the total thickness of the two layers located on both sides.

### [Positive Electrode Active Material Particles]

The positive electrode active material particles comprise a core section consisting of the positive electrode active material, and an active material coating section. The active material coating section covers the core section.

The positive electrode active material particles in the positive electrode active material layer may be single coated particles each having one core section and an active material coating section, or may be aggregated particles that are integrally aggregated and have a plurality of core sections and active material coating sections present between adjacent core sections, or a mixture thereof. In terms of ease of reducing impedance, it is preferable for the positive electrode active material particles to include aggregated particles.

### (Coated Particles)

In the coated particles, an active material coating section containing a conductive material is present on the surfaces of the positive electrode active material particles. The active material coating section enables the positive electrode active material particles to further enhance the battery capacity and cycling performance.

The active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that comes off in the steps following the preparation step of a positive electrode composition.

For example, the active material coating section stays on the surface of the core section of the positive electrode active material particles even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section in the coated particles preferably covers 50% or more, preferably 70% or more, and more preferably 90% or more of the total area of the entire outer surfaces of the positive electrode active material particles.

That is, the coated particles have a core section that is a positive electrode active material and an active material coating section that covers the surface of the core section, and the area ratio (i.e., coverage) of the coated section with respect to the surface area of the core section is preferably 50% or more, more preferably 70% or more, and even more preferably 90% or more.

Examples of the method for producing the coated particles include a vapor deposition method and a sintering method.

Examples of the vapor deposition method include a vapor phase deposition method such as a physical vapor deposition method and a chemical vapor deposition method, and a liquid phase deposition method such as plating.

Examples of the sintering method include a method that sinters an active material composition containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, sucrose, glucose, lactose, malic acid, citric acid, allyl alcohol, propargyl alcohol, ascorbic acid, and polyvinyl alcohol. With respect to these substances, a mixture of two or more kinds may be used, and an organic substance other than those listed above may also be used. This sintering method sinters an active material composition to allow carbon in the organic material to be fused to the surface of the positive electrode active material to thereby form the active material coating section.

Another example of the sintering method is the so-called impact sintering coating method.

The impact sintering coating method is carried out, for example, as follows. In an impact sintering coating device, a burner is ignited using a mixture of hydrocarbon fuel and oxygen, and a flame is generated by burning the mixture in a combustion chamber. In this process, the amount of oxygen is reduced to an amount equivalent to complete combustion of the fuel or less to lower the flame temperature. A powder supply nozzle is installed behind the flame, and a solid-liquid-gas three-phase mixture consisting of a slurry obtained by dissolving an organic matter for coating using a solvent, and a combustion gas is sprayed from the powder supply nozzle. By increasing the amount of combustion gas maintained at room temperature, the temperature of the sprayed fine powder is lowered, and the sprayed fine powder is accelerated at a temperature below the transformation temperature, sublimation temperature or evaporation temperature of the powder material, and is instantly sintered by impact to coat the particles of the positive electrode active material.

Examples of the vapor deposition method include a vapor phase deposition method such as a physical vapor deposition method and a chemical vapor deposition method, and a liquid phase deposition method such as plating.

To determine the area ratio (i.e., coverage) of the active material coating section relative to the surface area of the core section of the coated particles, the particles in the positive electrode active material layer are detected using a transmission electron microscope-energy dispersive X-ray spectroscopy (TEM-EDX) and the outer periphery of the positive electrode active material particle is subjected to elemental analysis using EDX. The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

Further, the active material coating section is a layer directly formed on the surface of particles composed of only the positive electrode active material (i.e., core sections), which has a thickness of 1 nm to 100 nm, preferably 5 nm to 50 nm. This thickness can be determined by the above-mentioned TEM-EDX used for the measurement of the coverage.

With respect to the coverage of the positive electrode active material particles, the determination can also be implemented by calculation from TEM-EDX elemental mapping of particles with elements specific to the positive electrode active material and elements specific to the conductive material in the active material coating section of the active material. Similarly, a ratio of the active material coating section to the entire circumference of the observed positive electrode active material particle may be determined as the coverage, with the coating being defined as at least 1 nm-thick portion of the element specific to the conductive material. The measurement can be performed with respect to, for example, 10 positive electrode active material particles, and an average value thereof can be used as a value of the coverage.

In the coated particles, the area ratio (coverage) of the active material coating section is particularly preferably 100% with respect to the surface area of the core section.

This ratio is an average value for all the positive electrode active material particles present in the positive electrode active material layer. As long as this average value is not less than the above lower limit value, the positive electrode active material layer may contain positive electrode active material particles without the active material coating section. When the positive electrode active material particles (i.e., single particles) without the active material coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer.

### (Aggregated Particles)

In the present specification, the expression “aggregated particles that are integrally aggregated” means aggregate particles that behave as a single particle when measuring the particle size distribution of particles present in the positive electrode active material layer described below, that is, aggregated particles that are recognized as a single particle in the aqueous dispersion used for particle size distribution measurement.

The aggregated particles include a plurality of particles composed only of the positive electrode active material, namely core sections, and have active material coating sections present between adjacent core sections.

At least a part of the outer surface of the aggregated particles is coated with the active material coating section. Of the outer surface area of the aggregated particles, the area covered with the active material coating section is preferably 50% or more, more preferably 70% or more, even more preferably 90% or more, particularly preferably 100%.

This coverage of the outer surface is an average value for all the aggregated particles present in the positive electrode active material layer. As long as this average value is not less than the above lower limit value, the positive electrode active material layer may contain aggregated particles without the active material coating section on the surface thereof.

The aggregated particles may be secondary particles (hereinafter also referred to as “granulated active material”) in which multiple core sections are granulated to be integrated through the active material coating section, or may be aggregates in which multiple coated particles are bound together by a binder, or may be aggregates in which multiple particles of granulated active material are bound together by a binder, or may be a mixture thereof.

Granulated active material can be manufactured by known methods (see, e.g., Japanese Patent No. 5509598). Alternatively, granulated active material may be commercially available products.

Aggregates containing the coated particles may contain particles other than the coated particles, such as conducting agents. Such aggregates may also contain components other than binders, such as dispersants.

Aggregates containing the granulated active material may contain particles other than the granulated active material, such as conducting agents. Such aggregates may also contain components other than binders, such as dispersants.

In other words, the aggregated particle is a particle which is an aggregate of positive electrode active material particles that are either particles consisting of only positive electrode active material, coated particles each having one core section and an active material coating section, or granulated active material having multiple core sections and active material coating sections with other positive electrode active material particles, conducting agents, binders, dispersants, etc., and is recognized as a single particle in an aqueous dispersion subjected to particle size distribution measurement.

In the granulated active material, the active material coating section is formed in advance, and present on the outer surface of the aggregated particles (granulated active material) and between adjacent core sections in the positive electrode active material layer. In other words, the active material coating section of the granulated active material, as in the case of the active material coating section of the coated particles, is not newly formed in the steps following the preparation step of a positive electrode composition. In addition, the active material coating section is not one that comes off in the steps following the preparation step of a positive electrode composition.

In the granulated active material, the area ratio of the active material coating section relative to the surface area of the core section (i.e., coverage) is preferably 50% or more, more preferably 70% or more, even more preferably 90% or more, particularly preferably 100%.

This coverage of the core section is an average value for all the core sections present in the positive electrode active material layer. As long as this average value is not less than the above lower limit value, the positive electrode active material layer may contain a small amount of core sections without the active material coating section on the surface thereof.

For the granulated active material, the area of and coverage by the active material coating section covering the surface of the core section or the active material coating section covering the outer surface can be determined, as in the case of the active material coating section of the coated particles, by detecting the particles in the positive electrode active material layer using a transmission electron microscope-energy dispersive X-ray spectroscopy (TEM-EDX) and performing elemental analysis of the outer periphery of the core section or the outer periphery of the aggregated particles (granulated active material) using EDX.

In the granulated active material, the active material coating section covering the outer surface and the active material coating section present between adjacent core sections are layers with a thickness of 1 nm to 100 nm, preferably 5 nm to 50 nm, formed directly on the surface of the particles composed only of the positive electrode active material, that is, the core sections, and this thickness can be determined by TEM-EDX used for measuring the coverage described above.

In the coated particles and the granulated active material, the conductive material in the active material coating section preferably contains carbon (conductive carbon). The conductive material may be composed only of carbon, or may be a conductive organic compound containing carbon and elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is 0.1 to 4.0% by mass, more preferably 0.5 to 3.0% by mass, even more preferably 0.7 to 2.5% by mass, based on the total mass of the coated particles or granulated active material. Excessive amount of the conductive material is not favorable in that the conductive material may come off the surface of the coated particles or the positive electrode active material particles and remain as isolated conducting agent particles.

Conductive particles that do not contribute to the creation of conductive path may become a site where self-discharge of the battery starts or a cause of undesirable side reactions.

The particle diameter of the positive electrode active material particles is preferably designed so that the median diameter B in the particle size distribution of the particles present in the positive electrode active material layer described below falls within a preferred range.

The average particle diameter of the coated particles is preferably 0.1 to 20.0 μm, more preferably 0.5 to 15.0 μm. When two or more types of the coated particles are used, each type of the coated particles may have an average particle diameter within the above range.

The average particle diameter of the granulated active material is preferably 3.0 to 20.0 μm, more preferably 5.0 to 15.0 μm. When two or more types of the granulated active material are used, each type of the granulated active material may have an average particle diameter within the above range.

The average particle size of the positive electrode active material particles in the present specification is a volume-based median particle size measured using a laser diffraction/scattering particle size distribution analyzer.

The positive electrode active material particles preferably contain a compound having an olivine crystal structure as a positive electrode active material.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”).

The positive electrode active material particles may include at least one type of other positive electrode active material particles including other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNixCo_{y}Alz_{O}2 with the proviso that x+y+z=1), lithium nickel cobalt manganese oxide (LiNiₓCoy_{Mn}zO₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn1.5Ni_{0.5}O₄), and lithium vanadium cobalt oxide, as well as nonstoichiometric compounds formed by partially substituting the compounds listed above with metal elements. Examples of the metal element include one or more selected from the group consisting of Mn, Mg, Ni, Co, Cu, Zn and Ge.

The other positive electrode active material particles may be single coated particles each having one core section, or secondary particles in which multiple core sections are granulated so as to be integrated through an active material coating section, i.e., granulated active material, or a mixture thereof.

The amount of the compound having an olivine type crystal structure is preferably 50% by mass or more, preferably 80% by mass or more, and even more preferably 90% by mass or more, based on the total mass of the positive electrode active material. The amount of the compound having an olivine type crystal structure may be 100% by mass, based on the total mass of the positive electrode active material particles.

### [Binder]

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The binder content relative to the total mass of the positive electrode active material layer is preferably 2.0% by mass or less, more preferably 1.5% by mass or less.

When the positive electrode active material layer contains a binder, the lower limit of the binder content relative to the total mass of the positive electrode active material layer is preferably 0.1% by mass or more, more preferably 0.3% by mass or more.

### [Conducting Agent]

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer is, for example, preferably 4 parts by mass or less, more preferably 3 parts by mass or less, and even more preferably 1 part by mass or less, relative to 100 parts by mass of the positive electrode active material. It is particularly preferable that the positive electrode active material layer does not contain a conducting agent, and it is desirable that there are no isolated conducting agent particles (for example, isolated carbon particles).

When the conducting agent is incorporated into the positive electrode active material layer, the lower limit value of the amount of the conducting agent is appropriately determined according to the type of the conducting agent, and is, for example, more than 0.1% by mass, based on the total mass of the positive electrode active material layer.

In the context of the present specification, the expression “the positive electrode active material layer does not contain a conducting agent” or similar expression means that the positive electrode active material layer does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

Conducting agent particles that do not contribute to the creation of conductive path may become a site where self-discharge of the battery starts or a cause of undesirable side reactions.

### [Dispersant]

The dispersant contained in the positive electrode active material layer 12 is an organic substance, and examples thereof include polyvinylpyrrolidone, polyvinyl alcohol, polyvinyl butyral, and polyvinylformal. With respect to these dispersants, a single type thereof may be used individually or two or more types thereof may be used in combination.

The dispersant contributes to improving the dispersion of particles in the positive electrode active material layer. On the other hand, when the dispersant content is too high, resistance is likely to increase.

The amount of the dispersant is preferably 0.5% by mass or less, more preferably 0.2% by mass or less, based on the total mass of the positive electrode active material layer.

When the positive electrode active material layer contains a dispersant, the lower limit of the amount of the dispersant is preferably 0.01% by mass or more, more preferably 0.05% by mass or more, based on the total mass of the positive electrode active material layer.

### [Positive Electrode Current Collector Main Body]

The positive electrode current collector body 14 is formed of a metal material. Examples of the metal material include conductive metals such as copper, aluminum, titanium, nickel, and stainless steel.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

The positive electrode current collector main body 14 has, on at least a part of its surface, a current collector coating layer 15. The current collector coating layer 15 contains a conductive material.

In this context, the expression “at least a part of its surface” means 10% to 100%, preferably 30% to 100%, more preferably 50% to 100% of the area of the surface of the positive electrode current collector main body.

The conductive material in the current collector coating layer 15 preferably contains carbon (conductive carbon). The conductive material is more preferably one composed only of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is defined as A μm. A is preferably less than 3.0 μm, more preferably 2.5 μm or less, even more preferably 2.0 μm or less. When A is less than 3.0 μm, the volumetric energy density can be easily increased. The lower limit of the thickness of the current collector covering layer 15 is not particularly limited, and may be within a manufacturable range. For example, A is preferably 0.01 μm or more, more preferably 0.05 μm or more, even more preferably 0.10 μm or more.

In one embodiment of the present invention, from the viewpoint of further enhancing the above-mentioned effect, A may be 0.1 μm or more and less than 1.0 μm, 0.1 to 0.7 μm, or 0.1 to 0.6 μm. The thickness of the current collector coating layer can be measured by a method that measures the thickness of the coating layer in a transmission electron microscope (TEM) image or a scanning electron microscope (SEM) image of a cross section of the current collector coating layer.

Alternatively, the thickness of the collector coating layer 15 can be determined by measuring the thickness of the positive electrode collector 11 and the thickness of the positive electrode collector main body 14 with a micrometer and subtracting the thickness of the positive electrode collector main body 14 from the thickness of the positive electrode collector 11.

The thickness of the collector coating layer 15 in the present specification is the average value of thicknesses at five predetermined points.

When the collector coating layer 15 is present on both sides of the positive electrode collector main body 14, the thickness of each of the collector coating layers 15 on both sides is measured.

When the current collector coating layer 15 is present on both sides of the positive electrode current collector main body 14, the current collector coating layer 15 on one side is removed with a cloth soaked in a solvent such as water until the positive electrode current collector main body 14 is completely exposed. The thickness is measured at a part where the current collector coating layer is present on one side and the positive electrode current collector main body is exposed on the other side, and the measured value is defined as thickness (i). The thickness is measured at a part where only the positive electrode current collector main body 14 is present and the current collector coating layer 15 is not present on both sides, that is, the thickness of the positive electrode current collector main body is measured, and the measured value is defined as thickness (ii). By subtracting the measured thickness (ii) from the measured thickness (i), the thickness information on the current collector coating layer 15 can be obtained.

### [Particle Size Distribution]

In the present specification, the particle size distribution of the particles present in the positive electrode active material layer 12 (hereinafter, also referred to as “particle size distribution of the positive electrode active material layer”) is a volume-based particle size distribution obtained by measurement using a laser diffraction/scattering particle size distribution analyzer.

A sample used for the measurement is an aqueous dispersion prepared by detaching the positive electrode active material layer 12 from the positive electrode 1 and dispersing the particles that had been present in the positive electrode active material layer 12 in water. For example, the outermost surface of the positive electrode active material layer with a depth of several μm is removed with a spatula or the like, and the resulting powder is dispersed in water to obtain an aqueous dispersion as a sample.

The aqueous dispersion is subjected to ultrasonic treatment to thoroughly disperse the particles, and then the particle size distribution is measured.

The median diameter in a particle size distribution of particles present in the positive electrode active material layer is defined as B μm.

The ratio A/B of the thickness A (μm) of the current collector coating layer to the median diameter B (μm) is 0.007 to 0.050, preferably 0.010 to 0.045, more preferably 0.015 to 0.040.

When A/B is not less than the lower limit value described above of the above range, it is easy to increase the volumetric energy density. When A/B is not more than the upper limit value described above, it is easy to reduce the impedance.

When A/B is within the above range, a good balance is achieved between the thickness of the current collector coating layer and the size of the positive electrode active material particles, which is presumed to optimize the state of contact between the current collector coating layer and the positive electrode active material particles.

For example, the larger the particle diameter of the positive electrode active material particles, the smaller the total surface area of the positive electrode active material particles in the positive electrode active material layer, which tends to result in higher contact resistances between the positive electrode active material particles and between the positive electrode active material particles and the current collector coating layer. The impedance at a frequency of 1 kHz is an index of these contact resistances. By setting A/B within the above range, a good state of contact between the current collector coating layer and the positive electrode active material particles is achieved, and the impedance at a frequency of 1 kHz decreases.

In one aspect of the present invention, from the viewpoint of further enhancing the above-mentioned effect, A/B may be 0.24 or more and 0.050 or less, or 0.30 or more and 0.050 or less.

The median diameter B is preferably 10.0 to 80.0 μm, more preferably 15.0 to 75.0 μm, even more preferably 20.0 to 70.0 μm.

When the median diameter B is within the above range, it is easy to increase the volumetric energy density and to reduce the impedance.

In addition, in one aspect of the present invention, from the viewpoint of further enhancing the above-mentioned effect, the median diameter B may be 10.0 μm or more and less than 64.0 μm, 10.0 to 30.0 μm, or 10.0 to 25.0 μm.

In addition, in the positive electrode 1 of the present embodiment, as shown in FIG. 1, when the current collector coating layer 15 and the positive electrode active material layer 12 are present on both sides of the positive electrode current collector 11, it is preferable that the thickness A, the median diameter B, and the A/B are within the respective ranges described above on both sides.

It is more preferable that the positive electrode active material particles contain the granulated active material and that the median diameter B is within the above range.

The use of the granulated active material enables the conductive path between the core sections to be improved. The impedance at a frequency of 0.1 Hz serves as an index of the resistance between the core sections. As the particle size of the granulated active material is increased, the core sections with good conductive paths increase, and the impedance at a frequency of 0.1 Hz decreases.

The granulated active material is secondary particles with unevenness on the particle surface, and when the particles of granulated active material aggregate with each other, the particles show an effect of interlocking with each other during pressing. In other words, the particles of granulated active material make good contact with each other and effectively form conductive paths, so that the electrical resistance of the resulting battery tends to be low. In contrast, the non-granulated active material is closer to spherical particles with less unevenness, so that particles thereof do not interlock well even during the pressing process, making poor contact on the electrode and poor conductive paths, and the resulting battery tends to have high electrical resistance.

### [Conductive Carbon Content]

In the present embodiment, the positive electrode active material layer 12 preferably includes conductive carbon. Examples of the embodiment in which the positive electrode active material layer contains the conductive carbon include the following embodiments 1 and 2.

Embodiment 1: An embodiment in which the positive electrode active material layer contains a conducting agent, and one or both of the conductive material of the active material coating section of the positive electrode active material particles and the conducting agent contain conductive carbon.

Embodiment 2: An embodiment in which the positive electrode active material layer contains no conducting agent, and the conductive material of the active material coating section of the positive electrode active material particles contain conductive carbon.

Embodiment 2 is more preferable in terms of improving the energy density of the battery.

The amount of the conductive carbon is preferably 0.5% by mass or more and less than 3.0 by mass, more preferably 1.0 to 2.8% by mass, even more preferably 1.2 to 2.6% by mass, based on the total mass of the positive electrode active material layer.

When the amount of the conductive carbon in the positive electrode active material layer is not less than the lower limit value of the above range, the amount is sufficient to form a conductive path in the positive electrode active material layer. When the amount is not more than the upper limit value described above, the dispersibility improves.

The amount of the conductive carbon relative to the total mass of the positive electrode active material layer can be calculated from the conductive carbon contents of the positive electrode active material particles and the conducting agent as well as the blended amount.

The conductive carbon content based the total mass of the positive electrode active material layer can be measured by <<Method for measuring conductive carbon content>> described below with respect to a dried product, as a measurement target, obtained by vacuum-drying, at 120° C., the positive electrode active material layer detached from the positive electrode.

For example, the measurement target may be one obtained by detaching the outermost surface of the positive electrode active material layer with a depth of several μm using a spatula or the like, and vacuum drying the resulting powder in an environment of 120° C.

The conductive carbon to be measured by the <<Method for measuring conductive carbon content>> described below includes carbon in the active material coating section, and carbon in the conducting agent. The conductive carbon content measured in the <<Method for measuring conductive carbon content>> described below does not include carbon in the binder. The conductive carbon content measured in the <<Method for measuring conductive carbon content>> described below does not include carbon in the dispersant.

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Temperature of combustion furnace: 1150° C.
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH2_{CF}2), molecular weight 64), the conductive carbon content can be calculated by the following formula from the fluoride ion (F₋) content (unit: % by mass) measured by combustion ion chromatography based on the tube combustion method, the atomic weight (19) of fluorine in the monomers constituting PVDF, and the atomic weight (12) of carbon in the PVDF.

PVDF content (unit: % by mass)=fluoride ion content (unit: % by mass)×64/38

PVDF-derived carbon amount M4 (unit: % by mass)=fluoride ion content (unit: % by mass)×12/19

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon content (unit: % by mass).

When the dispersant is contained, the conductive carbon content (unit: % by mass) can be obtained by subtracting M4 from M3, and further subtracting therefrom the amount of carbon belonging to the dispersant.

These methods are described in the following publications:
Toray Research Center, The TRC News No. 117 (September 2013), pp. 34-37, [Searched on Feb. 10, 2021], Internet <https://www.toray-research.co.jp/technical-info/trcnews/pdf/TRC117(34-37).pdf>
TOSOH Analysis and Research Center Co., Ltd., Technical Report No. T1019 2017 Sep. 20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material particles and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material particles, i.e., the coated particles. On the other hand, particles having a carbon-derived peak inside the particles can be judged to be the conducting agent. In this context, “near the particle surface” means a region to the depth of approximately 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material particles. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the active material coating section. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### [Volume Density of Positive Electrode Active Material Layer]<

In the present embodiment, the volume density of the positive electrode active material layer 12 is preferably 2.00 to 2.60 g/cm³, more preferably 2.05 to 2.50 g/cm³.

The volume density of the positive electrode active material layer can be measured by, for example, the following measuring method.

The thicknesses of the positive electrode 1 and the positive electrode current collector 11 are each measured with a micrometer, and the difference between these two thickness values is calculated as the thickness of the positive electrode active material layer 12. With respect to the thickness of the positive electrode 1 and the thickness of the positive electrode current collector 11, each of these thickness values is an average value of the thickness values measured at five or more arbitrarily chosen points. The thickness of the positive electrode current collector 11 may be measured at the exposed section 13 of the positive electrode current collector, which is described below.

The mass of the measurement sample punched out from the positive electrode 1 so as to have a predetermined area is measured, from which the mass of the positive electrode current collector 11 measured in advance is subtracted to calculate the mass of the positive electrode active material layer 12.

The volume density of the positive electrode active material layer 12 is calculated by the following formula (1).

Volume density (unit: g/cm³)=mass of positive electrode active material layer (unit: g)/[(thickness of positive electrode active material layer (unit: cm))×area of measurement sample (unit: cm²)] (1)

When the volume density of the positive electrode active material layer is not less than the lower limit value of the above range, it is easy to increase energy density of the resulting non-aqueous electrolyte secondary battery. When the volume density is not more than the upper limit value described above, cracks due to press load are unlikely to occur in the positive electrode active material layer, so that an excellent conductive path can be formed.

The volume density of the positive electrode active material layer can be controlled by, for example, adjusting the amount of the positive electrode active material, the particle size of the positive electrode active material, the thickness of the positive electrode active material layer, and the like. When the positive electrode active material layer contains a conducting agent, the volume density can also be controlled by selecting the specific surface area and specific gravity of the conducting agent, or adjusting the amount of the conducting agent or the particle size of the conducting agent.

### <Method for Producing Positive Electrode>

The present embodiment's method for producing the positive electrode 1 includes a composition preparation step of preparing a positive electrode composition containing a positive electrode active material, and a coating step of coating the positive electrode composition on the positive electrode current collector 11.

For example, the positive electrode 1 can be produced by applying the positive electrode composition containing a positive electrode active material and a solvent onto the positive electrode current collector 11, followed by drying to remove the solvent to form the positive electrode active material layer 12. The positive electrode composition may contain a conducting agent. The positive electrode composition may contain a binder. The positive electrode composition may contain a dispersant.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. The non-aqueous electrolyte secondary battery 10 may further include a separator 2. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

### [Negative Electrode]

The negative electrode active material layer 32 includes a negative electrode active material. Further, the negative electrode active material layer 32 may further include a binder. Furthermore, the negative electrode active material layer 32 may include a conducting agent as well. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as natural graphite and artificial graphite, lithium titanate, silicon, silicon monoxide, and silicon oxides. Examples of the carbon materials include graphite, graphene, hard carbon, Ketjen black, acetylene black, and carbon nanotube. With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11.

Examples of the binder in the negative electrode composition include polyacrylic acid, lithium polyacrylate, polyvinylidene fluoride, polyvinylidene fluoride-propylene hexafluoride copolymer, styrene-butadiene rubber, polyvinyl alcohol, polyethylene oxide, polyethylene glycol, carboxymethyl cellulose, polyacrylonitrile, polyimide, and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

The sum of the amount of the negative electrode active material and the amount of the conducting agent relative to the total mass of the negative electrode active material layer 32 is preferably 80.0 to 99.9% by mass, more preferably 85.0 to 98.0% by mass.

### [Separator]

The separator 2 is disposed between the negative electrode 3 and the positive electrode 1 to prevent a short circuit or the like. The separator 2 may retain a non-aqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The separator 2 may contain at least one of plasticizers, antioxidants, and flame retardants. Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte]

The non-aqueous electrolyte fills the space between the positive electrode 1 and the negative electrode 3. For example, any of known non-aqueous electrolytes used in lithium ion secondary batteries, electric double layer capacitors and the like can be used.

As the non-aqueous electrolyte, a non-aqueous electrolyte solution in which an electrolyte is dissolved in an organic solvent is preferable.

After manufacture, that is, after initial charging, the nonaqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrohydrafuran, 2-methyltetrahydrofuran, dioxolane, and methyl acetate, as well as mixtures of two or more of these polar solvents.

The electrolyte is not particularly limited, and examples thereof include lithium-containing salts such as lithium perchlorate, lithium hexafluorophosphate, lithium tetrafluoroborate, lithium hexafluoroarsenate, lithium trifluoroacetate, lithium bis(fluorosulfonyl)imide, and lithium bis(trifluoromethanesulfonyl)imide, or mixtures of two or more of these salts.

Examples of additives includes a compound A that contains one or both of a sulfur atom and a nitrogen atom. Each of the additives may be used alone, or two or more of the additives may be used in combination.

Examples of the compound A include lithium bis(fluorosulfonyl)imide (LiN(SO₂F)₂, hereafter also referred to as “LiFSI”) and lithium bis(trifluoromethanesulfonyl)imide (LiN(SO₂CF₃)₂, hereafter also referred to as “LiTFSI”).

### <Method for Producing Non-Aqueous Electrolyte Secondary Battery>

Examples of the method for producing a non-aqueous electrolyte secondary battery according to the present embodiment include a method in which a positive electrode, a separator, a negative electrode, a non-aqueous electrolyte solution, an exterior body, etc. are put together by a known method to assemble a non-aqueous electrolyte secondary battery.

An example of the method for producing a non-aqueous electrolyte secondary battery according to the present embodiment is described below. For example, an electrode stack is produced in which a positive electrode 1 and a negative electrode 3 are alternately interleaved with a separator 2 interposed therebetween. The electrode laminate is put into an exterior body 5 such as an aluminum laminate bag. Then, a non-aqueous electrolyte solution is injected into the exterior body 5, and the exterior body 5 is sealed to produce a non-aqueous electrolyte secondary battery.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples which, however, should not be construed as limiting the present invention.

### <Measuring Method>

### [Method for Measuring Thickness]

The thickness of the positive electrode sheet and the thickness of the positive electrode current collector at its exposed section 13 were measured using a micrometer. The current collector coating layer 15 at the exposed section 13 of the positive electrode current collector was removed, and the thickness of the positive electrode current collector main body 14 was measured. Each thickness was measured at 5 arbitrarily chosen points, and an average value was calculated.

The thickness at the exposed section 13 of the positive electrode current collector was defined as the thickness of the positive electrode current collector 11. The thickness of the current collector coating layer (total of both sides) was calculated by subtracting the thickness of the positive electrode current collector main body 14 from the thickness of the exposed section 13 of the positive electrode current collector, and half of this value was defined as the thickness A of the current collector coating layer on one side.

### [Particle Size Distribution Measuring Method]

The outermost surface of the positive electrode active material layer with a depth of several μm was removed with a spatula or the like, and the resulting powder was dispersed in water to obtain a dispersion as a sample.

The measurement was implemented using a laser diffraction particle size distribution analyzer (product name “LA-960V2”, manufactured by Horiba, Ltd.), and a flow cell. The sample was circulated, stirred and irradiated with ultrasonic waves (10 minutes), and the particle size distribution was measured while keeping the dispersion state sufficiently stable.

A volume-based particle size distribution curve was obtained to determine the median diameter B (D50) and distribution width (D90−D10).

### [Volume Density Measuring Method]

5 sheets of measurement samples were prepared by punching the positive electrode sheet into circles with a diameter of 16 mm.

The mass of each measurement sample was weighed with a precision balance, and the mass of the positive electrode active material layer in the measurement sample was calculated by subtracting the mass of the positive electrode current collector measured in advance from the measurement result. The volume density of the positive electrode active material layer was calculated from the average value of measurements by the above formula (1).

The thickness of the positive electrode active material layer (total of both sides) in the formula (1) was calculated by subtracting the thickness of the exposed section 13 of the positive electrode current collector from the thickness of the positive electrode sheet.

### Evaluation Method

### [Measurement Method for Impedance (Alternating Current Resistance)]

A cell was prepared so as to have a rated capacity of 1 Ah, and the obtained cell was charged at a constant current rate of 0.2 C (that is, 200 mA) and with a cut-off voltage of 3.6 V at room temperature (25° C.), and then charged at a constant voltage with a cut-off current set at 1/10 of the above-mentioned charge current (that is, 20 mA). Then, impedance was measured under the conditions of room temperature (25° C.) and two different frequencies, 1 kHz and 0.1 Hz.

The measurement was carried out by 4-terminal method in which a current terminal and a voltage terminal are attached to the positive and negative electrode tabs, respectively. As an example, an impedance analyzer manufactured by BioLogic was used for the measurement.

### [Measurement Method for Volumetric Energy Density]

The evaluation of the volumetric energy density was performed according to the following procedures (1) to (3).

(1) A cell was prepared so as to have a rated capacity of 1 Ah, and the volume of the cell was measured. The volume was measured by Archimedes' principle. The volume measurement may be performed by other methods. To name a few, a method using a laser volume meter or a 3D scan can be employed.

(2) In an environment of 25° C., the obtained cell was charged at a constant current rate of 0.2 C (that is, 200 mA) and with a cut-off voltage of 3.6 V, and then charged at a constant voltage with a cut-off current set at 1/10 of the above-mentioned charge current (that is, 20 mA). Then, a 30-minute pause was provided while leaving the cell in the open circuit state.

(3) The cell was discharged at a constant current rate of 0.2 C and with a cut-off voltage of 2.5 V. In this process, the volumetric energy density (unit: Wh/L) was calculated by dividing the total discharge power (unit: Wh) measured from the start of discharge to the end of discharge by the cell volume (unit: L) measured in (1).

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a 8 μm-thick copper foil and vacuum dried at 100° C. Then, the resulting was pressure-pressed under a load of 2 kN to obtain a negative electrode sheet. The obtained negative electrode sheet was punched to obtain a negative electrode.

### Production Example 2: Production of Current Collector Having Current Collector Coating Layer

A slurry was obtained by mixing 100 parts by mass of carbon black, 40 parts by mass of polyvinylidene fluoride as a binder, and N-methylpyrrolidone as a solvent. The amount of NMP used was the amount required for applying the slurry.

The obtained slurry was applied to both sides of a 15 μm-thick aluminum foil (that is, positive electrode current collector main body) by a gravure method, and dried to remove the solvent, thereby obtaining a positive electrode current collector. The current collector coating layers on both surfaces were formed so as to have the same amount of coating and the same thickness. The thickness A of the current collector coating layer after drying (on one side) was adjusted by the coating volume.

The positive electrode active material particles used were granulated active material in which a large number of core sections (lithium iron phosphate) were integrated via active material coating sections (carbon), or single coated particles (non-granulated product) consisting of a core section (lithium iron phosphate) and an active material coating section (carbon).

Granulated active material (1): average particle size 19.4 μm, carbon content 2.5% by mass.

Granulated active material (2): average particle size 14.5 μm, carbon content 1.5% by mass.

Granulated active material (3): average particle size 7.8 μm, carbon content 1.5% by mass.

Granulated active material (4): average particle size 31.1 μm, carbon content 1.5% by mass.

Coated particle (1): average particle size 0.9 μm, carbon content 1.1% by mass, coverage 90% or more.

When granulated active materials (1) to (4) were observed with a scanning electron microscope (SEM) and a transmission electron microscope (TEM) equipped with a mapping function, all of them were found to be roughly spherical particles containing numerous core sections formed of lithium iron phosphate, i.e., granulated products. Carbon was present between adjacent core sections, and the outer surface of the granulated product was covered with a thin film of carbon. The coverage of the core sections was 90% or more, and the coverage of the outer surface was 90% or more.

Polyvinylidene fluoride was used as a binder.

N-methylpyrrolidone was used as a solvent.

As a positive electrode current collector, the aluminum foil having the current collector coating layer obtained in Production Example 2 was used.

### Examples 1 to 8

Examples 1 to 5 are implementation of the present invention, while Examples 6 to 8 are comparative examples.

A positive electrode active material layer was formed by the following method.

With the blending ratio shown in Table 1, the positive electrode active material particles, the binder, and n-methylpyrrolidone were mixed with a mixer to obtain a positive electrode composition. The amount of the solvent used was the amount required for applying the positive electrode composition. The blending amounts in the table are percentage values relative to the total 100% by mass of the positive electrode active material particles and the binder.

The obtained positive electrode composition was applied to both surfaces of the positive electrode current collector, and after pre-drying, the applied composition was vacuum-dried at 120° C. to form positive electrode active material layers. The coating volume of the positive electrode composition was 20 mg/cm² in terms of the total volume for both sides. The positive electrode active material layers on both surfaces of the positive electrode current collector were formed so as to have the same coating amount and the same thickness. The obtained laminate was pressure-pressed to obtain a positive electrode sheet. The load for the pressure-press was set to 10 kN.

The obtained positive electrode sheet was punched to obtain a positive electrode.

For the obtained positive electrode sheet, the thickness A of the current collector coating layer, the particle size distribution of the positive electrode active material layer, the conductive carbon content relative to the total mass of the positive electrode active material layer, and the volume density of the positive electrode active material layer were determined. The results are shown in Table 2.

Specifically, the thickness A of the current collector coating layer, the particle size distribution of the positive electrode active material layer, and the thickness and volume density of the positive electrode active material layer were measured by the respective methods described above. The median diameter B was obtained from the particle size distribution, and A/B was calculated.

The conductive carbon content relative to the total mass of the positive electrode active material layer was calculated based on the carbon content and blending amount of the positive electrode active material particles. The conductive carbon content can also be determined by the method described in the above <<Method for measuring conductive carbon content>>.

A non-aqueous electrolyte secondary battery having a configuration shown in FIG. 2 was manufactured by the following method.

Lithium hexafluorophosphate as an electrolyte was dissolved at 1 mol/L in a solvent in which ethylene carbonate (hereinafter referred to as EC) and diethyl carbonate (hereinafter referred to as DEC) were mixed at a volume ratio, EC:DEC, of 3:7, to thereby prepare a non-aqueous electrolytic solution.

As a separator, a polyolefin film having a thickness of 15 μm was used. The positive electrode obtained above and the negative electrode obtained in Production Example 1 were alternately interleaved through a separator to prepare an electrode layered body with its outermost layer being the negative electrode.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (i.e., laminate cell).

The impedance and volumetric energy density were measured by the above methods. The results are shown in Table 2.

TABLE 1

| | Positive electrode composition | | | |
|---|---|---|---|---|
| | Positive electrode active material | | Conducting | |
| | particles | | agent | Binder |
| | | Amount | Amount | Amount |
| | | [% by | [% by | [% by |
| | Type | mass] | mass] | mass] |
| Ex. 1 | Granulated active | 99.0 | 0 | 1 |
| | material (1) | | | |
| Ex. 2 | Granulated active | 99.0 | 0 | 1 |
| | material (1) | | | |
| Ex. 3 | Granulated active | 99.0 | 0 | 1 |
| | material (1) | | | |
| Ex. 4 | Granulated active | 98.0 | 1 | 1 |
| | material (2) | | | |
| Ex. 5 | Granulated active | 98.0 | 1 | 1 |
| | material (3) | | | |
| Ex. 6 | Granulated active | 99.0 | 0 | 1 |
| | material (4) | | | |
| Ex. 7 | Coated particles (1) | 98.5 | 0.5 | 1 |
| Ex. 8 | Granulated active | 96.0 | 3 | 1 |
| | material (3) | | | |

TABLE 2

| | Thickness A of | Positive electrode active material layer | | | | | | |
|---|---|---|---|---|---|---|---|---|
| | current collector | | Conductive | | | | | Volumetric |
| | coating layer | Median | carbon | Volume | | Impedance | | energy |
| | (one side) | diameter B | content | density | A/B | 1 kHz | 0.1 Hz | density |
| | Unit | | | | | | | |
| | μm | μm | % by mass | g/cm³ | — | mQ | mQ | Wh/L |
| Ex. 1 | 0.6 | 68.6 | 2.5 | 2.2 | 0.009 | 12 | 24 | 256 |
| Ex. 2 | 1 | 66.7 | 2.5 | 2.2 | 0.015 | 10 | 22 | 254 |
| Ex. 3 | 1.5 | 64.4 | 2.5 | 2.1 | 0.023 | 10 | 22 | 241 |
| Ex. 4 | 0.6 | 27.2 | 2.5 | 2.3 | 0.022 | 12 | 28 | 271 |
| Ex. 5 | 0.5 | 12.9 | 2.5 | 2.4 | 0.039 | 12 | 34 | 283 |
| Ex. 6 | 0.5 | 124.7 | 1.5 | 2.0 | 0.004 | 86 | 110 | 215 |
| Ex. 7 | 0.5 | 1.8 | 1.6 | 2.45 | 0.278 | 10 | 94 | 289 |
| Ex. 8 | 3 | 10.3 | 4.5 | 2.0 | 0.291 | 8 | 30 | 213 |

As can be understood from the results in Table 2, in Examples 1 to 5 in which A/B was 0.007 or more and 0.050 or less, the impedance of the non-aqueous electrolyte secondary battery was low and the volumetric energy density was high.

Examples 1, 4, and 5 were similar in terms of the thickness A of the current collector coating layer and different in terms of the median diameter B. In Examples 1, 4, and 5, the impedance at 1 KHz was similar, but the impedance at 0.1 Hz decreased as B increased.

In the impedance evaluation at high frequency (1 kHz), electronic resistance, i.e., resistance within the current collector foil and resistance due to contact between the current collector foil and the coating layer or active material layer, etc., are mainly detected. In the impedance evaluation at 0.1 Hz, in addition to the high-frequency electronic resistance, also detected are charge transfer resistance, i.e., resistance when lithium ions are inserted into and extracted from the inside of electrode to cause charge transfer, and diffusion resistance, i.e., resistance when lithium ions diffuse into the electrolyte solution and move. Therefore, the impedance evaluation at 0.1 Hz is important for evaluating resistance components that affect cycle performance, etc.

On the other hand, in Example 6, where A/B is less than 0.007, the thickness A of the current collector coating layer was similar to that of Examples 1, 4, and 5, but the impedance at 1 kHz and 0.1 Hz was higher than those of Examples 1, 4, and 5. Further, the volume density was low, and the volumetric energy density was also low. It is presumed that the contact between the positive electrode active material particles and the contact between the positive electrode active material particles and the current collector coating layer were insufficient because B was too large compared to A.

In Example 7, where A/B exceeds 0.050, the thickness A of the current collector coating layer was similar to that of Examples 1, 4, and 5, but B was small, so that the impedance at 0.1 Hz was higher than those of Examples 1, 4, and 5.

In Example 8, where A/B exceeds 0.050, the median diameter B was similar to that of Example 5, but A was large, so that the volumetric energy density was lower than that of Example 5.

### EXPLANATION OF REFERENCE NUMERALS

1 Positive electrode
2 Separator
3 Negative electrode
5 Outer casing
10 Secondary battery
11 Positive electrode current collector
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector

1. A positive electrode for a non-aqueous electrolyte secondary battery, comprising a current collector and a positive electrode active material layer provided on the current collector, wherein:
the current collector has, on at least a part of its surface on a side of the positive electrode active material layer, a current collector coating layer,
the positive electrode active material layer comprises positive electrode active material particles,
the positive electrode active material particles comprise a core section consisting of a positive electrode active material, and an active material coating section covering the core section,
each of the current collector coating layer and the active material coating section comprises a conductive material, and
when a thickness of the current collector coating layer is defined as A μm and a median diameter in a particle size distribution of particles present in the positive electrode active material layer is defined as B μm, A/B is 0.007 or more and 0.050 or less.

2. The positive electrode according to claim 1, wherein B is 10.0 to 80.0 μm.

3. The positive electrode according to claim 1, wherein A is less than 3.0 μm.

4. The positive electrode according to claim 1, wherein the positive electrode active material layer comprises a conductive carbon, and an amount of the conductive carbon is 0.5% by mass or more and less than 3.0% by mass, based on a total mass of the positive electrode active material layer.

5. The positive electrode according to claim 1, wherein the positive electrode active material particles comprise a compound represented by a formula LiFeₓM₍₁₋ₓ₎PO₄, wherein 0≤x≤1, M is Co, Ni, Mn, Al, Ti or Zr.

6. The positive electrode according to claim 1, wherein the positive electrode active material layer comprises a binder.

7. A non-aqueous electrolyte secondary battery, comprising the positive electrode of claim 1, a negative electrode, and a non-aqueous electrolyte disposed between the positive electrode and the negative electrode.

8. A battery module or battery system comprising a plurality of the non-aqueous electrolyte secondary batteries of claim 7.
